(19) United States
(12) Patent Application Publication
(10) Pub. No.: US 2020/0239236 A1
(43) Pub. Date: Jul. 30, 2020

(54) APPARATUS FOR CONVEYING ARTICLES

(71) Applicant: Campbell Wrapper Corporation, De Pere, WI (US)

(72) Inventors: Jeffrey Ginzl, Pulaski, WI (US); Michael Jarmuskiewicz, Green Bay, WI (US); Michael Klasen, De Pere, WI (US)

(21) Appl. No.: 16/751,960

(22) Filed: Jan. 24, 2020

Related U.S. Application Data
(60) Provisional application No. 62/796,951, filed on Jan. 25, 2019.

(51) Int. Cl. B65G 15/42; B65G 47/31; B65G 43/08

(52) U.S. Cl. CPC B65G 15/42; B65G 47/31; B65G 2812/02217; B65G 2203/0233; B65G 43/08

(57) ABSTRACT

A feeder apparatus for conveying articles, comprises a first, gap-closing conveyor, and a second, lugged conveyor positioned downstream of said first, gap-closing conveyor. The gap-closing conveyor accepts randomly or irregularly spaced articles from an upstream conveyor or other feeder. The gap-closing conveyor is operated at a speed which is sufficient to always provide a gap between articles received on the gap-closing conveyor from an upstream conveyor or associated feeder. The second, lugged conveyor is operated at a speed which is the same as the downstream wrapper or other packaging device to which the regularly spaced articles are being supplied. The apparatus includes upper and lower moving junction carriages which respectively join opposite ends of said first, gap closing conveyor and said second, lugged conveyor. In operation, the upper and lower junctions are movable such that irregularly spaced articles on the gap-closing conveyor can be positioned in regularly spaced relationship on the lugged conveyor between adjacent ones of the upstanding lugs. The articles or group of multiple articles can then be delivered in the desired regularly spaced relationship to an associated packaging apparatus or other handling device.

### CROSS-REFERENCE TO RELATED APPLICATIONS

This application claims priority of Provisional Ser. No. 62/796,951, filed Jan. 25, 2019, the disclosure of which is hereby incorporated by reference in its entirety.

### FEDERALLY SPONSORED RESEARCH OR DEVELOPMENT

Not Applicable.

### MICROFICHE/COPYRIGHT REFERENCE

Not Applicable.

### FIELD OF THE INVENTION

The present invention is directed to a feeder apparatus and method for conveying articles, wherein randomly or irregularly spaced apart articles are accepted on an upstream conveyor and transferred to a downstream conveyor in regularly spaced relationship for subsequent packaging or other processing.

### BACKGROUND OF THE INVENTION

In the course of handling and packaging articles, including food products and the like, it is frequently necessary to handle a stream of randomly or irregularly spaced apart articles, and arrange them in a regularly spaced stream. This permits the stream of regularly spaced articles to be directed to associated packaging equipment or the like for packaging or other handling.

Heretofore, arranging a stream of irregularly spaced articles into a regularly spaced stream, while avoiding contact between the articles, has required specialized equipment, including so-called correction belts, to ensure the desired regular spacing of the articles for subsequent handling.

The present invention contemplates an improved conveying arrangement which permits a stream of irregularly or randomly spaced articles to be positioned in regularly spaced relationship on a conveyor, without any product-to-product contact, and without the need for correction belts or other similar ancillary equipment.

### SUMMARY OF THE INVENTION

In accordance with the present invention, a feeder apparatus for conveying articles, comprises a first, gap-closing conveyor, and a second, lugged conveyor positioned downstream of said first, gap-closing conveyor. The gap-closing conveyor accepts randomly or irregularly spaced articles from an upstream conveyor or other feeder. The gap-closing conveyor is operated at a speed which is sufficient to always provide a gap between articles received on the gap-closing conveyor from an upstream conveyor or associated feeder. The second, lugged conveyor is operated at a speed which is the same or ratioed to the downstream wrapper or other packaging device to which the regularly spaced articles are being supplied.

The first, gap-closing conveyor is operated at a higher speed than the second, lugged conveyor. The second, lugged conveyor has plurality of upstanding, evenly spaced-apart lugs between adjacent ones of which one of the articles, or multiple articles, can be conveyed.

The present feeder apparatus further includes upper and lower moving junction carriages which respectively join opposite ends of said first, gap closing conveyor and said second, lugged conveyor. The downstream end of the first, gap-closing conveyor is connected to the upper moving junction, with the upper and lower moving junctions being selectively movable in unison, in opposite directions, to selectively lengthen or shorten an upper run of the first, gap closing conveyor, and an upper run of the second, lugged conveyor.

In operation, the upper and lower moving junctions are movable such that irregularly spaced articles on the gap-closing conveyor can be positioned in regularly spaced relationship on the lugged conveyor between adjacent ones of the upstanding lugs. The articles or group of multiple articles can then be delivered in the desired regularly spaced relationship to an associated packaging apparatus or other handling device.

When an article, or multiple articles, arrives at the end of the upper run of the gap-closing conveyor belt, and is in the process of being transferred onto the lugged belt, the upper moving junction will index upstream of the feeder apparatus, shortening the upper run of the gap-closing conveyor, to permit a lug of the lugged conveyor to be brought up behind the article, or group of articles. The lug in front of the article will act as a stop for the article if it slides during the transition from the gap-closing belt to the lugged belt. The article is now captured in between lugs and will be conveyed to the former of the wrapper, or other apparatus. Prior to the former of the wrapper, the article will be pushed or dragged back against the lug so it will be accurately loaded into the wrapper's former or other apparatus.

As the upper moving junction carriage position changes based on the flow of incoming product, the wrapper speed will be changed to keep the machine running based on the calculated position of the upper moving junction carriage. As the upper junction moves towards the downstream end of the feeder apparatus, the wrapper will slow down. As the moving junction carriage moves towards the upstream end of the apparatus, the wrapper will speed up. The position at which these speed changes occur, and the amount of speed change are settable in the machine program.

When the amount of product supplied to the present feeder apparatus is not sufficient to maintain running the wrapper, or a like interruption in operation occurs, the wrapper will stop in a position such that the upper moving junction carriage can move in the downstream direction of the feeder, when enough product is supplied to the feeder to start running the wrapper. The wrapper and the downstream movement of the upper moving junction carriage is started prior to the product reaching the upper moving junction carriage to allow for a gentle start of the wrapper. The rate of movement takes into consideration the coefficient of friction between the product and the lug belt during the product transition from the gap-closing conveyor belt to the lugged conveyor belt to minimize misplacement of product onto the lugged conveyor belt.

An input for the control of the apparatus is provided by a sensor for monitoring the position of each the articles on the first, gap-closing conveyor. This sensor may comprise a photo eye mounted at a fixed location just after the articles are received on the first gap-closing conveyor. The sensor measures the length of each article and log the article position.

A method of conveying articles in accordance with the present invention comprises the steps of providing a first, gap-closing conveyor, and a second, lugged conveyor positioned downstream of the first, gap-closing conveyor. The method includes operating the first, gap-closing conveyor at a higher speed than the second, lugged conveyor, wherein the second, lugged conveyor is provided with a plurality of upstanding, evenly spaced-apart lugs between adjacent ones of which one of the articles, or groups of articles, can be conveyed.

The present method further includes providing upper and lower moving junctions which respectively join opposite ends of the first, gap closing conveyor and the second, lugged conveyor. By this arrangement, the upper and lower moving junctions are selectively movable in unison, in opposite directions, to selectively lengthen or shorten an upper run of the first, gap closing conveyor.

In operation, a plurality of articles is provided to the first, gap-closing conveyor in irregularly or randomly spaced apart relationship, with the upper and lower junctions selectively moved in unison to selectively vary a length of an upper run of the first gap-closing conveyor. In this manner, irregularly spaced apart articles are transferred from the first, gap-closing conveyor to the lugged conveyor in regularly spaced apart relationship between adjacent ones of the upstanding lugs.

Additional features of the present invention will be apparent from the following description. Desirably, single products, or leading and trailing products of a group, will not touch other products. A single product, or groups of products, can be placed between the upstanding lugs on the lugged conveyor.

Other features and advantages of the present invention will become readily apparent from the following detailed description, the accompanying drawings, and the appended claims.

### BRIEF DESCRIPTION OF THE DRAWINGS

FIG. 1 is a diagrammatic perspective view of a conveying apparatus embodying the principles of the present invention;

FIG. 2 is a relatively enlarged, diagrammatic perspective view further illustrating the conveying apparatus of the present invention;

FIG. 3 is a perspective, diagrammatic view illustrating the operation of the conveying apparatus of the present invention; and

FIG. 4 is a perspective, diagrammatic view further illustrating operation of the conveying apparatus of the present invention.

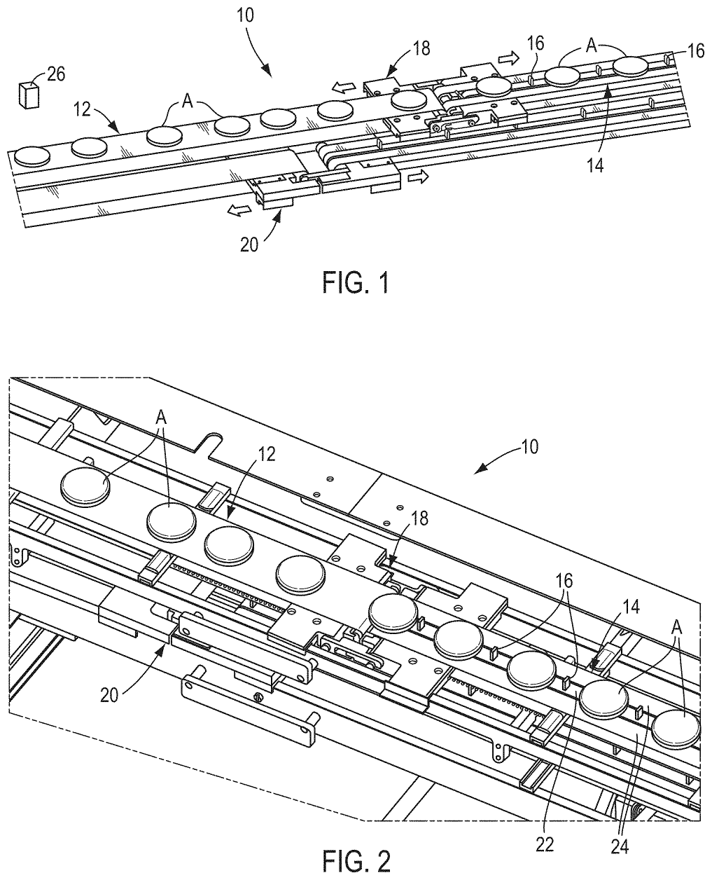

### DETAILED DESCRIPTION OF THE INVENTION

While the present invention is susceptible of embodiment in various forms, there is shown in the drawings and will hereinafter be described a presently preferred embodiment, with the understanding that the present disclosure is intended as an exemplification of the invention, and is not intended to limit the invention to the specific embodiment illustrated.

In accordance with the present invention, a feeder apparatus 10 for conveying articles, comprises a first, gap-closing conveyor 12, and a second, lugged conveyor 14 positioned downstream of the first, gap-closing conveyor 12. The gap-closing conveyor 12 accepts randomly or irregularly spaced articles, designated A, from an upstream conveyor or other feeder. The gap-closing conveyor 12 is operated at a speed which is sufficient to always provide a gap between articles A received on the conveyor from an upstream conveyor or associated feeder. The second, lugged conveyor 14 is operated at a speed which is the same or ratioed to an associated downstream wrapper or other packaging device to which the regularly spaced articles A are being supplied.

The first, gap-closing conveyor 12 is operated at a higher speed than the second, lugged conveyor 14. The second, lugged conveyor 14 has plurality of upstanding, evenly spaced-apart lugs 16 between adjacent ones of which one of the articles A, or multiple articles, can be conveyed.

The present feeder apparatus 10 further includes upper and lower moving junction carriages 18, 20 which respectively join opposite ends of said first, gap closing conveyor 12 and said second, lugged conveyor 14. The downstream end of the first, gap-closing conveyor 12 is connected to the upper moving junction 18, with the upper and lower moving junctions being selectively movable in unison, in opposite directions, to selectively lengthen or shorten an upper run of the first, gap closing conveyor 12, and an upper run of the second, lugged conveyor 14.

In operation, the upper and lower moving junctions 18, 20 are movable such that irregularly spaced articles A on the gap-closing conveyor 12 can be positioned in regularly spaced relationship on the lugged conveyor 14 between adjacent ones of the upstanding lugs 16. The articles A, or group of multiple articles, can then be delivered in the desired regularly spaced relationship to an associated packaging apparatus or other handling device.

When an article A, or multiple articles, arrive at the end of the upper run of the belt of the gap-closing conveyor 12, and is in the process of being transferred onto the lugged belt 14, the upper moving junction 18 will index upstream, shortening the upper run of the gap-closing conveyor 12, to permit a lug 16 of the lugged conveyor 14 to be brought up behind the article A, or a group of the articles. The lug 16 in front of the article A will act as a stop for the article if it slides during the transition from the gap-closing conveyor 12 to the belt of the lugged conveyor 14. The article A is now captured in between lugs 16, and will be conveyed to the former of the wrapper, or other apparatus. Prior to the former of the wrapper, the article A will be pushed or dragged back against the lug 16 so it will be accurately loaded into the wrapper's former or other apparatus.

As the positions of the moving junction carriages 18, 20 change, based on the flow of incoming product, the wrapper speed will be changed to keep the machine running based on the calculated position of the upper moving junction carriage. As the upper junction 18 moves towards the downstream end of the feeder apparatus 10, the wrapper will slow down. As the upper moving junction carriage 18 moves toward the upstream end of the feeder apparatus 10, the associated wrapper will speed up. The position at which these speed changes occur, and the amount of speed change are settable in the machine program.

When the amount of product supplied to the present feeder apparatus 10 is not sufficient to maintain running the wrapper, the wrapper will stop in a position such that the upper moving junction carriage 18 can move in the downstream direction when enough product is supplied to the feeder to start running the wrapper. The wrapper, and the downstream movement of the upper moving junction carriage 18, is started prior to the product reaching the moving junction carriage 18 to allow for a gentle start of the wrapper. The rate of movement takes into consideration the coefficient of friction between the product and the lugged conveyor 14 during the product transition from the gap-closing conveyor 12 to the lugged conveyor 14 to minimize misplacement of product onto the lugged conveyor belt.

In accordance with the illustrated embodiment, the lugged conveyor 14 comprises three conveying elements comprising three belts, or two belts and one chain, a central, infeed lug belt/chain 22 having the upstanding lugs 16, and a pair of carrier belts 24, without lugs, positioned on respective opposite sides of the central, infeed lug belt 22 (see FIG. 4). Thus, the central belt/chain 22 comprises a lugged belt/chain, and the carrier belts 24 on each side of the central belt/chain 22 do not have lugs. The central lugged belt/chain 22 transports product into the associated wrapper's former and film tube or other apparatus. While the illustrated embodiment of the present invention shows the conveying elements of the lugged conveyor 14 as comprising lug belt/chain 22 and carrier belts 24, either the lug belt/chain and/or carrier belts may comprise chains.

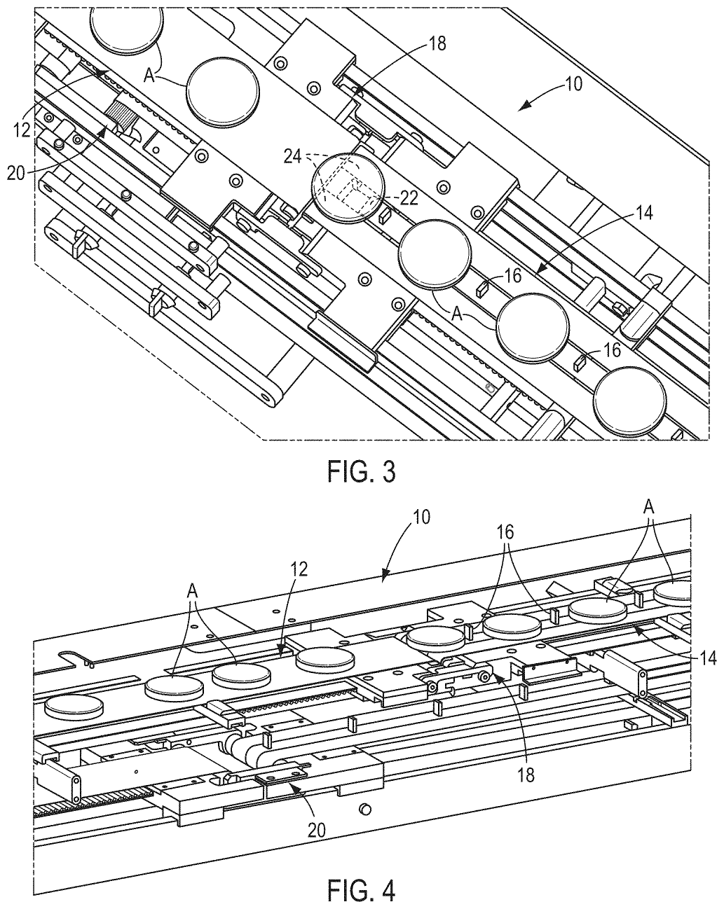

The carrier belts 24 extend beyond the central infeed lug belt/chain 22 at the upper moving junction 18 (see phantom line illustration in FIG. 3). As each article A is transferred from the gap-closing conveyor 12 to the lugged conveyor 14, each article is moved onto the carrier belts 24, while one of the lugs 16 on the central lugged belt/chain 22 is moved into position behind the article.

An input for the control of the feeder apparatus 10 is provided by a sensor 26 for monitoring the position of each the articles on the first, gap-closing conveyor. This sensor may comprise a photo eye mounted at a fixed location just after the articles are received on the first gap-closing conveyor 12. The sensor 26 measures the length of each article A and logs the article position.

A method of conveying articles in accordance with the present invention comprises the steps of providing a first, gap-closing conveyor 12, and a second, lugged conveyor 14 positioned downstream of the first, gap-closing conveyor 12. The method includes operating the first, gap-closing conveyor 12 at a higher speed than the second, lugged conveyor 14. The second, lugged conveyor 14 is provided with a plurality of upstanding, evenly spaced-apart lugs 16 between adjacent ones of which one of the articles (or groups of the articles) can be conveyed.

The present method further includes providing upper and lower moving junctions 18, 20, which respectively join opposite ends of the first, gap-closing conveyor 12 and the second, lugged conveyor 14. By this arrangement, the upper and lower moving junctions 18, 20 are selectively movable in unison, in opposite directions, to selectively lengthen or shorten an upper run of the first, gap closing conveyor 12, and the upper run of the second, lugged conveyor 14.

In operation, a plurality of articles A are provided to the first, gap-closing conveyor 12 in irregularly or randomly spaced apart relationship, with the upper and lower junctions 18, 20 selectively moved in unison to selectively vary a length of an upper run of the first gap-closing conveyor. In this manner, irregularly spaced apart articles A are transferred from the first, gap-closing conveyor 12 to the lugged conveyor 14 in regularly spaced-apart relationship between adjacent ones of said upstanding lugs 16.

In the preferred practice, the present method includes positioning a trailing edge of each of the articles A against one of the upstanding lugs 16 of the second, lugged conveyor 14.

In operation, the first belt of the feeder apparatus 10, the gap-closing conveyor 12, will accept randomly spaced products from an upstream conveyor. The speed of the gap-closing conveyor 12 is set to be fast enough to always have a gap between each article A supplied to the feeder 10. The photo eye 26, or other suitable sensor, mounted at a fixed location just after the product is on the gap-closing conveyor 12, measures the length of each product A and logs the product position. The downstream end roller of the gap-closing conveyor 12 is attached to the upper moving junction carriage 18.

On the downstream end of the upper moving junction carriage 18, there are conveying elements in the form of three belts, or two belts and one chain. As noted, the center belt/chain is a lugged belt/chain 22, and the carrier belts 24 on each side of the center belt/chain do not have lugs. The center, lugged belt/chain 22 transports product into the wrapper's former and film tube. The belts 22, 24 mounted to the downstream side of the upper moving junction carriage 18 are run at a same relative speed as, or ratioed to, the film speed of the wrapper.

When a product A, or multiple products, arrive at the end of the upper run of the gap-closing conveyor 12, and are in the process of being transferred onto the lugged conveyor 14, the upper moving junction carriage 18 indexes upstream of the feeder apparatus 10 to bring a lug 16 up behind the product A, or group of products. The lug 16 in front of the product A acts as a stop for the product if it slides during the transition from the gap-closing conveyor 12 to the lugged conveyor 14. The product A is now captured in between adjacent ones of the lugs 16, and will be conveyed to the former. Prior to the former, the product will be pushed back against the trailing lug 16 so it will be accurately loaded into the wrapper's former and into the film tube.

As the upper moving junction carriage 18 position changes based on the flow of incoming product, the wrapper speed will be changed to keep the machine running based on the calculated position of the upper moving junction carriage. As the upper junction carriage 18 moves towards the downstream end of the feeder apparatus 10, the wrapper will slow down. As the upper moving junction carriage 18 moves towards the upstream end of the feeder apparatus 10, the wrapper will speed up. The position at which these speed changes happen, and the amount of speed change are settable in the machine program.

When the amount of product A supplied to the feeder is not enough to maintain running the wrapper, the wrapper will stop in a position such that the upper moving junction carriage 18 can move in the downstream direction when enough product is supplied to the feeder apparatus 10 to start running the wrapper. The wrapper and the downstream movement of the upper moving junction carriage 18 is started prior to the product reaching the upper moving junction carriage 18, to allow for a gentle start of the wrapper. The rate of movement takes into consideration the coefficient of friction between the product and the lugged conveyor 14 during the product transition from the gap-closing conveyor 12 to the lugged conveyor 14 to minimize misplacement of product onto the lugged belt.

Additional features of the present invention will be apparent from the foregoing description. Desirably, single products, or leading and trailing products of a group, will not touch other products. A single product, or groups of products, can be placed between the upstanding lugs 16 on the lugged conveyor 14.

In operation, the wrapper and the downstream movement of the upper moving junction carriage 18 is started prior to the product reaching the upper moving junction carriage 18 to allow for a gentle start of the wrapper. The rate of movement takes into consideration the coefficient of friction between the product and the lugged conveyor 14 during the product transition from the gap-closing conveyor 12 to the lugged conveyor 14, to minimize misplacement of product onto the lugged conveyor belt. The wrapper can be stopped in a position such that the upper moving junction carriage 18 can move in the downstream direction when enough product is supplied to the feeder to start running the wrapper.

From the foregoing, it will be observed that numerous modifications and variations can be effected without departing from the true spirit and scope of the novel concept present invention. It is to be understood that no limitations with respect to the specific embodiment illustrated herein is intended or should be inferred. The disclosure is intended to cover by the appended claims all such modifications as fall within the scope of the claims.

1. An apparatus (10) for conveying articles (A), comprising:
a first, gap-closing conveyor (12), and a second, lugged conveyor (14) positioned downstream of said first, gap closing conveyor (12),
said first, gap-closing conveyor (12) being operated at a higher speed than said second, lugged conveyor (14),
said second, lugged conveyor (14) having a plurality of upstanding, evenly spaced-apart lugs (16) between adjacent ones of which one or multiple ones of said articles (A) can be conveyed;
upper and lower moving junctions (18, 20) which respectively join opposite ends of said first, gap-closing conveyor (12) and said second, lugged conveyor (14),
said upper and lower moving junctions (18, 20) being selectively movable in unison, in opposite directions, to selectively lengthen or shorten an upper run of said first, gap-closing conveyor (12) and an upper run said second, lugged conveyor (14);
said upper and lower moving junctions (18, 20) being movable such that irregularly spaced ones of said articles (A) on said first, gap-closing conveyor (12) can be positioned in regularly spaced relationship on said second, lugged conveyor (14) between adjacent ones of said upstanding lugs (16).

2. An apparatus (10) for conveying articles (A) in accordance with claim 1, wherein
said second, lugged conveyor (14) comprises a central, infeed lug conveying element having said upstanding lugs (16), and a pair of carrier conveying elements positioned on respective opposite sides of said central, infeed lug conveying element, said carrier conveying elements extending beyond said central, infeed conveying element at said upper moving junction.

3. An apparatus (10) for conveying articles (A) in accordance with claim 1, including
a sensor for monitoring the position of each said article on said first, gap-closing conveyor (12).

4. A method of conveying articles (A), comprising the steps of:
providing a first, gap-closing conveyor (12), and a second, lugged conveyor (14) positioned downstream of said first, gap-closing conveyor (12),
wherein said first, gap-closing conveyor (12) is operated at a higher speed than said second, lugged conveyor (14), and said second, lugged conveyor (14) has a plurality of upstanding, evenly spaced-apart lugs (16) between adjacent ones of which one of said articles (A) can be conveyed;
providing upper and lower moving junctions (18, 20) which respectively join opposite ends of said first, gap-closing conveyor (12) and said second, lugged conveyor (14),
wherein said upper and lower moving junctions (18, 20) are selectively movable in unison, in opposite directions, to selectively lengthen or shorten an upper run of said first, gap-closing conveyor (12);
providing a plurality of articles (A) to said first, gap-closing conveyor (12) in irregularly spaced apart relationship; and
selectively moving said upper and lower junctions (18, 20) in unison to selectively vary a length of an upper run of said first gap-closing conveyor (12) so that said irregularly spaced apart articles (A) are transferred from said first, gap-closing conveyor (12) to said second, lugged conveyor (14) in regularly spaced apart relationship between adjacent ones of said upstanding lugs (16).

5. A method of conveying articles (A) in accordance with claim 4, including
positioning a trailing edge of an article (A) against one of said upstanding lugs (16) of said second, lugged conveyor.

6. A method of conveying articles (A) in accordance with claim 4, including
moving said upper moving junction in a downstream direction, after an interruption in the articles being conveyed and prior to the articles on the gap-closing conveyor reaching the upper moving junction.
